(19) United States
(12) Patent Application Publication
(10) Pub. No.: US 2014/0068308 A1
(43) Pub. Date: Mar. 6, 2014

(54) PORTABLE TERMINAL, METHOD AND PROGRAM FOR EXECUTING TRANSMISSION AND RECEPTION OF DATA

(71) Applicant: Yoshinori MATSUMOTO, Osaka-shi (JP)

(72) Inventor: Yoshinori MATSUMOTO, Osaka-shi (JP)

(21) Appl. No.: 14/014,808

(22) Filed: Aug. 30, 2013

(30) Foreign Application Priority Data
Sep. 5, 2012 (JP) 2012-195150

(51) Int. Cl. G06F 1/32

(52) U.S. Cl. CPC G06F 1/3206
USPC 713/323

(57) ABSTRACT

To provide a portable terminal, method or/and program that can reduce the energy consumption by automatically transmitting and receiving data based on the signal strength, rather than the user manually transitioning from sleep mode to active mode. The terminal processing means 18 commands the terminal to transition from the sleep mode to active mode based on the signal strength, and the data transmission and/or reception means 13 to perform data transfers.

### CROSS REFERENCE TO RELATED APPLICATION

The present application claims priority from Japanese Patent Application No. 2012-195150, which was filed on Sep. 5, 2012, the disclosure of which is herein incorporated by reference in its entirety.

### BACKGROUND OF THE INVENTION

1. Field of the Invention

This invention relates to a portable terminal, method and program for transmitting and receiving data and relates specifically to a sleep and activation feature.

2. Description of Related Art

The recent addition of high-functioning and multi-functioning features to portable phones has been contributing to the increase of energy consumption by these portable phones. Enlarging the battery capacity is quite difficult, considering the size and weight of these phones. Transitioning the phones into sleep mode when they are not in use enables the reduction of energy consumption level.

The terminals enter into a sleep mode when they do not receive data for a certain amount of time, and recover from the sleep mode once they begin receiving data, as it is cited in the patent documents (e.g., Japanese Unexamined Patent Application Publication No. 2004-104465 and Japanese Unexamined Patent Application Publication No. 2004-64328).

However, the method mentioned above required users to open a data transfer application to check if any data has been saved while the terminal had a weak signal. In order to use the terminal after the change in the signal strength, users were required to transition from sleep mode to a normal mode, and open a data transfer application. This process causes unnecessary consumption of energy for the users.

This invention aims to provide a program for transmitting and receiving data depending on the signal strength without requiring user's operation, thus saving energy consumption.

### SUMMARY OF THE INVENTION

This invention provides a portable terminal to perform the following steps:

Characteristic 1: The signal strength determination means that measures the signal strength of the wireless network, the sleep means that transitions the terminal into a sleep mode depending on the signal strength, the activation means that activates the terminal by the signal strength, the data transmission and reception means that transmits and receives data when the terminal is activated, and the processing means that transitions the terminal into a sleep mode after the data transmission and reception is complete.

According to this invention, the data transmission and/or reception application is activated, as the terminal transitions from sleep mode to active mode when the signal is strong. When the data transmission and/or reception is completed, the terminal transitions again into sleep mode.

Therefore, the energy can be saved because the data saved in the data server can be received automatically, without the user manually and unnecessarily transitioning the terminal from sleep mode to regular mode.

Characteristic 1 may be applied not only to a portable terminal, but program and/or method, with the similar effects.

Characteristic 2: Time measurement means, which measures the elapsed time of the signal strength. When the measurement means detects a signal weaker than the predetermined level, and the signal does not recover to the predetermined level for a period of time predetermined by the time measurement means, the terminal will transition into a sleep mode.

Characteristic 2 presents that if the signal does not recover for a predetermined period of time, then the terminal transitions into a sleep mode.

Therefore, the portable terminal will transition into a sleep mode when it has a weak signal, rather than performing unnecessary data transmission and/or reception.

Characteristic 2 may be applied not only to a portable terminal, but program and/or method, with the similar effects.

Characteristic 3: When the terminal detects a stronger signal than the predetermined level, the terminal begins data transmission and/or reception through the wireless network, and transitions into a sleep mode when the transmission and/or reception is complete.

Characteristic 3 presents that the terminal is able to conserve energy, while performing definite data transmission and/or reception, by transmitting and receiving data only when the signal is strong.

Characteristic 3 may be applied not only to a portable terminal, but also to a program and/or method, with the similar effects.

Characteristic 4: Operation determination means. If this means detects a user operating the terminal, the sleep transition will be halted.

Characteristic 4 presents that the sleep means will be halted when there is user operation, regardless of the signal strength.

This means prevents the terminal from mistakenly transitioning into a sleep mode when the user is operating the terminal.

Characteristic 4 may be applied not only to a portable terminal, but also to a program and/or method, with the similar effects.

Characteristic 5: Display determination means. This means determines whether information is shown on the display. When determined that the display is in use, the sleep transition will be halted.

Characteristic 5 presents that the sleep means will be halted when the display is in use, regardless of the signal strength.

This means prevents the terminal from mistakenly transitioning into a sleep mode when the display is in use for a long period of time—such as when the user is watching videos on the terminal.

Characteristic 5 may be applied not only to a portable terminal, but also to a program and method, with the similar effects.

This invention provides a portable terminal, as well as a program, to conserve energy by automatically transmitting and receiving data according to the signal strength, rather than the user manually transitioning the terminal from one mode to another.

Finally, a portable terminal in accordance with the invention is capable of transmitting and receiving data through a wireless network and includes an input device which a user can operate, a display device capable of displaying an image, and a controller. The controller is programmed so as to execute the processing of (A) measuring a signal strength of the wireless network and (B) transmitting and receiving data by activating an application configured to perform data transmission and/or reception when a state continues for a predetermined time, the state being a state in which the input device is not operated by the user, the image is not displayed on the display device and the signal strength measured in the processing (A) exceeds a standard level, and then transitioning the portable terminal into a sleep mode in which the application is not activated, by terminating the application.

### BRIEF DESCRIPTION OF THE DRAWINGS

FIG. 1 explains an outline of this embodiment.

FIG. 2 illustrates a structure block of portable terminal 1.

FIG. 3 illustrates a function block of portable terminal 1.

FIG. 4 illustrates a flow of the processing terminal 1 executes.

### DESCRIPTION OF THE PREFERRED EMBODIMENTS

A preferred embodiment of the invention will be explained with reference to the figures. The following explanation is only one of the examples, and the technical range of this invention is not restricted solely by the following explanation.

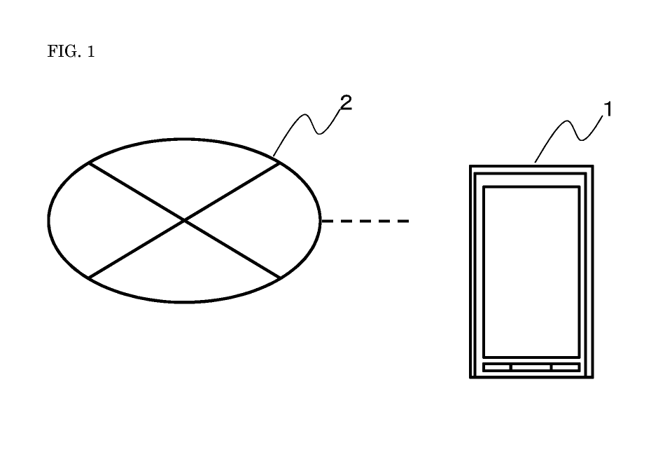

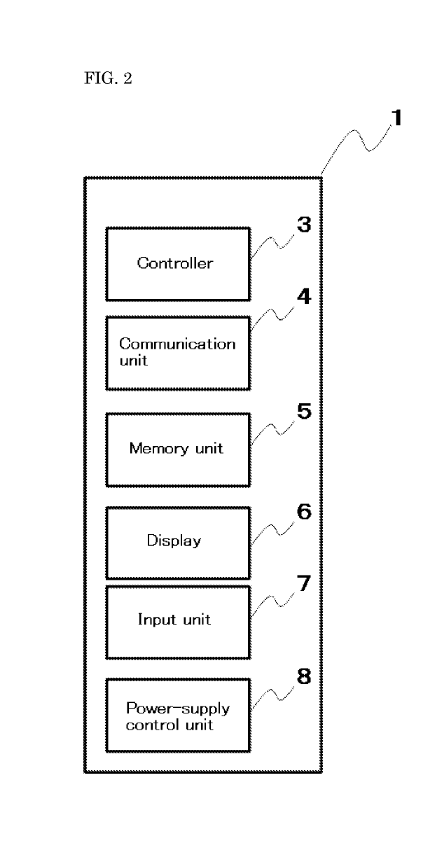

The summary of this embodiment will be explained with references to FIGS. 1 and 2. As FIG. 1 indicates, a portable terminal 1 performs wireless communication through wireless network 2. Examples of a portable terminal are cell phones, smartphones, laptops, and other portable data devices.

Portable terminal 1, as indicated by FIG. 2, is provided with controller 3, communication unit 4, memory unit 5, display 6, input unit 7, and power-supply control unit 8. Portable terminal 1 may be provided with an alarm device, which is not shown in the figures. The alarm device may be, for example, an audio output device such as a speaker, a vibration device, and a light output device such as light-emitting diode. It is preferable to utilize, as an alarm device, a speaker originally installed in portable terminal 1.

Controller 3 is provided with CPU (Central Processing Unit), RAM (Random Access Memory), and ROM (Read Only Memory). Communication unit 4 is provided with a wireless communication device, and performs data transmission and reception (hereinafter called data transmission and/or reception) through the antenna (not pictured in the figures). Memory unit 5 is provided with either or both of HDD (Hard Disk Drive), and SSD (Solid State Drive). Display 6 is provided with a monitor such as LCD to show images. Display 6 shows objects, which are items that are displayed on portable terminal 1. A file that is stored in portable terminal 1, and icons that are displayed by active applications are examples of these objects.

Input unit 7 is provided with buttons for receiving user's inputs, and a touch panel on display 6.

Power-supply control unit 8 is provided with a battery that provides the portable terminal 1 with power supply.

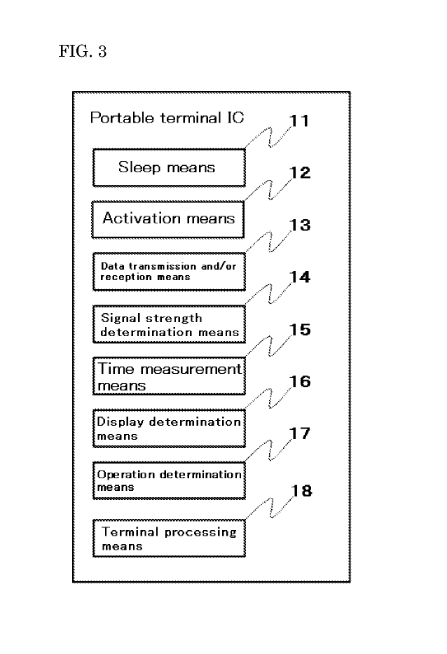

As indicated in FIG. 3, portable terminal 1 is provided with sleep means 11, activation means 12, data transmission and/or reception means 13, signal strength determination means 14, time measurement means 15, display determination means 16, operation determination means 17, and terminal processing means 18. These means are executed by controller 3, communication unit 4, memory unit 5, display 6, input unit 7, and/or power-supply control unit 8.

Sleep means 11 has a feature of transitioning the portable terminal 1 into a sleep mode. The sleep mode, according to this invention, is defined as a state where power-supply control unit 8 stops providing electric power supply to most of the internal devices while remaining to provide electric power supply to at least data transmission and/or reception means 13 and signal strength determination means 14.

Activation means 12 has a feature of activating the portable terminal 1 from a sleep mode. Active mode is defined as a state where an application required to perform data transmission and/or reception by the data transmission and/or reception means 13 is activated. Data transmission and/or reception means 13 has a feature of performing data transmission and/or reception through wireless network 2.

The signal, received by the data transmission and/or reception means 13, is measured by the signal strength determination means 14. Signal strength determination means 14 determines whether the strength of the received signal exceeds a standard signal level A. The data of the standard signal level can be stored in the memory unit 5, or other parts such as the controller 3. The standard signal level A is not limited. For example, if levels 0 to N are indicated on the display in a stepwise fashion as a signal level, those levels may be the standards. Specifically, the standard signal level A may be a value which satisfies the maximum level N or a level higher than N−1.

Time measurement means 15 has a feature of measuring a time elapsed since the signal strength measurement means 14 determines the signal strength. The data of the measured time is sent to the controller 3 to be used for processing performed by the terminal processing means 16, which will be described later.

Display determination means 16 determines whether an object is shown on display 6.

Operation determination means 17 determines whether input unit 7 is operated.

Terminal processing means 18 activates the portable terminal 1 from a sleep mode by the activation means 12, performs data transmission and/or reception by the data transmission and/or reception means 13, and transitions the terminal into a sleep mode once the data transmission and/or reception is complete.

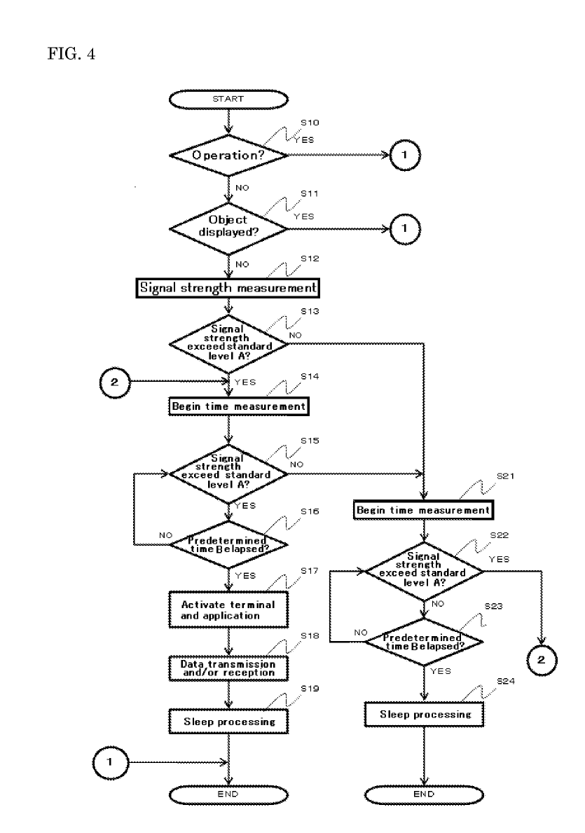

FIG. 4 shows a flow of the processing.

First, the portable terminal 1 determines whether there is a user operation, by the operation determination means 17 (Step S10). User operation is determined, for example, when the user is inputting data into the terminal 1. This avoids a situation where the terminal will mistakenly transition into a sleep mode when the signal becomes weak during user's operation.

Secondly, the terminal determines whether an object(s) is shown on display 6, by the display determination means 16 (Step S11). In Step S10 and Step S11, it is determined whether the terminal is currently in a sleep mode. In Step S10 and Step S11, the terminal does not transition into a sleep mode if the user is operating the terminal, or an object is shown on display 6. These prevent the terminal from transitioning into a sleep mode, for example, when the user is watching a video on the terminal.

Signal strength determination means 14 measures the strength of the signal received by the data transmission and/or reception means 13 (Step S12), and determines if the measured strength exceeds the standard level A (Step S13).

If the signal strength determination means 14 determines that the strength of the signal received by the data transmission and/or reception means 13 exceeds the standard level A (Step S13 YES), the time measurement means 15 begins a time measurement (Step S14). The measured time will be sent to the controller 3. The signal strength determination means 14 again determines whether the strength of the signal received by the data transmission and/or reception means 13 exceeds the standard level A (Step S15). If the signal strength determination means 14 determines that the signal strength exceeds the standard level A (Step S15 YES), the controller 3 determines whether the time which the time measurement means 15 has measured since Step S14 has elapsed a predetermined time B (Step S16). The data of the predetermined time B is stored in memory unit 5. The predetermined time B is not limited but may preferably be a time expected to allow for steady communication. The predetermined time B may preferably be not less than 1 second and less than 10 minutes, more preferably not less than 5 seconds and less than 5 minutes, yet more preferably not less than 10 seconds and less than 3 minutes, most preferably not less than 30 seconds and less than 1 minute. For example, when communication is interrupted intermittently, it is preferable not to initiate data communication. The predetermined time B may be 0. In Step S15, if the signal strength satisfies the standard level A, Step S17 may be initiated immediately.

If the controller 3 determines that the time which the time measurement means 15 has measured since Step S14 has elapsed the predetermined time B stored in memory unit 5 (Step S16 YES), the terminal processing means 18 transitions the terminal into an active mode by activation means 12, and activates the application that performs data transmission and/or reception (Step S17). The terminal processing means 18 then executes data transmission and/or reception by the data transmission and/or reception means 13 (Step S18). In Step S18, a predetermined alarm may be given by the alarm device on completion of the data transmission and/or reception. For example, audio output, vibration output, or light output may be performed selectively or in combination. The manner of alarm activation may change depending on the status of such as data reception. For example, the manner of alarm activation may change according to the signal strength in data transmission and/or reception. This enables a user to know of completion of data transmission and/or reception without viewing display 6, and to learn the signal strength. When it is expected to take a great deal of time for data transmission and/or reception, for example over 5 minutes, 10 minutes, 30 minutes, or 1 hour, a user may be requested to enter to select whether to perform this communication. Whether to perform communication under this situation may be preset. For example, a user may preset a threshold value of such as an expected time taken for data transmission and/or reception, or such as data capacity. It may be controlled so that when exceeding the threshold value, data transmission and/or reception will not be performed. When the processing related to the data transmission and/or reception means 13 is complete, the terminal processing means 18 terminates the application, and transitions the terminal into a sleep mode (Step S19).

In Step S13 and Step S15, if the signal strength determination means 14 determines that the strength of the signal received by the signal data transmission and/or reception means 13 falls below the standard level A (Step S13 NO, 15 NO), the time measurement means 15 begins a time measurement (Step S21). The measured time is sent to the controller 3. The signal strength determination means 14 again determines whether the strength of the signal received by the data transmission and/or reception means 13 exceeds the standard level A (Step S22). If the signal strength determination means 14 determines that the signal strength falls below the standard level A (Step S22 NO) and the controller 3 determines whether the time which the time measurement means 15 has measured since Step S21 has elapsed a predetermined time C (Step S23 YES), the terminal processing means 18 will transition the terminal into a sleep mode by sleep means 11 (Step S24). The predetermined time C is not limited but may preferably be a time expected to allow the signal strength to be maintained below the standard level A for a continuous period of time. Namely, when decrease of the signal strength continues only for a short time, it is preferable not to go into the sleep mode.

If the signal strength determination means 14 determines that the strength of the signal received by data transmission and/or reception means 13 exceeds the standard level A (Step S22 YES), the terminal returns to Step S14. If a user operates portable terminal 1 during this routine, it is preferable to perform interrupt processing to end this routine. Accordingly, if a user carries out an operation during the routine, the sleep processing is halted. If this occurs during data transmission and/or reception, it is preferable to continue data transmission and reception. It may be controlled so that the interrupt processing is performed only when a user operates portable terminal 1 after transitioning into the sleep mode in Step S19 or Step S24.

Step S10 and Step S11 may be performed in the reverse order. Therefore, the display determination means 16 may first determine whether an object is shown on display 6, and then determine whether the user is operating the terminal, by operation determination means 17.

When a user is in an environment where the signal strength is weak, the aforesaid processing enables data transmission and/or reception to be performed automatically after the signal strength improves. This allows a user to automatically perform data transmission and/or reception when the signal strength improves, thereby eliminating the need to unnecessarily transition the terminal from the sleep mode to the active mode. This lowers energy consumption.

The aforementioned means, units, features and functions are realized by a computer reading and executing predetermined programs (including CPU, data process device, and other terminals). The application programs are supplied in the forms of such as flexible discs, CD (CD-ROM), DVD (DVD-ROM and DVD-RAM), and other computer readable medium. In this case, the computer loads the application program from the medium, sends the program to an internal or external memory unit, and executes the program. The program may also be firstly stored in memory devices such as magnetic discs, optical discs, and magneto-optical discs, and then supplied to the computer through communication lines.

This concludes the embodiment of this invention; however, this invention is not limited to the aforesaid embodiments. The effects and results stated in this embodiment were enumerated as the most ideal results, and the effects of this invention are not limited to the ones mentioned in the embodiment.

### SUMMARY OF CODES

1: Portable terminal
2: Wireless network
3: Controller
4: Communication unit
5: Memory unit
6: Display
7: Input unit
8: Power-supply control unit
11: Sleep means
12: Activation means
13: Data transmission and/or reception means
14: Signal strength determination means
15: Time measurement means
16: Display determination means
17: Operation determination means
18: Terminal processing means

What is claimed is:

1. In a portable terminal that is provided with a data transmission and/or reception function that transmits and receives data through a wireless network:
The signal measurement means, which measures the signal strength of the wireless network,
The sleep means, which transitions the portable terminal into a sleep mode depending on the signal strength,
The activation means, which activates the portable terminal depending on the signal strength,
The terminal processing means, which commands the data transmission and/or reception means to perform data transmission and/or reception through the wireless network when the terminal is activated, and the sleep means to transition the terminal into a sleep mode once the data transmission and/or reception is complete.

2. When the signal measurement means detects a signal weaker than the predetermined strength, the time measurement means measures the elapsed time since the weak signal has been detected.
The signal measurement means measures the signal strength after the predetermined time has elapsed. The sleep means transitions the portable terminal into a sleep mode when the second signal measurement cannot detect a signal stronger than the predetermined strength. Applied to the portable terminal stated in claim 1.

3. When the signal measurement means detects a signal stronger than the predetermined strength, the terminal processing means commands the data transmission and/or reception means to perform data transmission and/or reception through the wireless network data, and the sleep means to transition into a sleep mode once the data transmission and/or reception is complete. Applied to the portable terminal stated in claim 1.

4. When the operation determination means, which determines whether the user is operating the terminal, determines that there is a user operation, the terminal processing means halts the sleep means; preventing the terminal from transitioning into a sleep mode. Applied to the portable terminal stated in claim 1.

5. When the display determination means, which determines whether there are any items shown on the display, determines that the display is in use, the terminal processing means halts the sleep means; preventing the terminal from transitioning into a sleep mode. Applied to the portable terminal stated in claim 1.

6. The program that is provided with the following steps:
Data transmission and/or reception means that performs data transmissions and reception through a wireless network,
Signal measurement means that measures the signal strength of the wireless network,
Sleep means that transitions the portable terminal into a sleep mode depending on the signal strength,
Activation means that activates the portable terminal depending on the signal strength, and
Terminal processing means that commands the data transmission and/or reception means to transfer data once the terminal is activated, and the sleep means to transition the terminal into a sleep mode once the data transmission and/or reception is complete.

7. When the signal measurement means measures a signal weaker than the predetermined strength, the time measurement means begins to measure the elapsing time since the first signal measurement. After a predetermined time elapses, the signal measurement means measures the strength of the signal. When the second measurement does not measure a signal stronger than the predetermined strength, the sleep means transitions the terminal into a sleep mode. Applied to the program stated in claim 6.

8. When the signal measurement means detects a signal stronger than the predetermined strength, the terminal processing means commands the data transmission and/or reception means to perform data transmission and/or reception through the wireless network data, and the sleep means to transition into a sleep mode once the data transmission and/or reception is complete. Applied to the program stated in claim 6.

9. When the operation determination means, which determines whether the user is operating on the terminal, determines that there is a user operation, the terminal processing means halts the sleep means; preventing the terminal from transitioning into a sleep mode. Applied to the program stated in claim 6.

10. When the display determination means, which determines whether there are any items shown on the display, determines that the display is in use, the terminal processing means halts the sleep means; preventing the terminal from transitioning into a sleep mode. Applied to the program stated in claim 6.

11. The following is the method for the portable terminal, provided with a data transmission and/or reception means, to execute this invention:
Signal measurement means that measures the signal strength of the wireless network,
Sleep means that transitions the portable terminal into a sleep mode depending on the signal strength,
Activation means that activates the portable terminal depending on the signal strength, and
Terminal processing means that commands the data transmission and/or reception means to transfer data once the terminal is activated, and the sleep means to transition the terminal into a sleep mode once the data transmission and/or reception is complete.

12. When the signal measurement means measures a signal weaker than the predetermined strength, the time measurement means begins to measure the elapsing time since the first signal measurement. After a predetermined time elapses, the signal measurement means measures the strength of the signal. When the second measurement does not measure a signal stronger than the predetermined strength, the sleep means transitions the terminal into a sleep mode. Applied to the method stated in claim 11.

13. The terminal processing means commands the data transmission and/or reception means to transfer data once the terminal is activated, and the sleep means to transition the terminal into a sleep mode once the data transmission and/or reception is complete. Applied to the method stated in claim 11.

14. Provided with an operation determination means, which determines whether the user is operating the terminal; the terminal processing means halts the sleep means from transitioning the terminal into a sleep mode when the operation determination means determines that the user is operating the terminal. Applied to the program stated in claim 11.

15. Provided with a display determination means, which determines whether the display is in use; the terminal processing means halts the sleep means from transitioning the terminal into a sleep mode when the display determination means determines that the display is in use. Applied to the program stated in claim 11.

16. The portable terminal according to claim 1 further comprising an alarm device, wherein the alarm device gives an alarm, after the activation means activates the portable terminal, when the data transmission and/or reception by the data transmission and/or reception means is completed.

17. The program according to claim 6, wherein the portable terminal further comprises an alarm device,
and wherein the program is designed to further execute a step of giving an alarm by the alarm device, after the activation means activates the portable terminal, when the data transmission and/or reception by the data transmission and/or reception means is completed.
